(19) United States
(12) Patent Application Publication
(10) Pub. No.: US 2011/0203172 A1
(43) Pub. Date: Aug. 25, 2011

(54) Protective garden enclosure

(76) Inventors: Jeffery Lynn Bailey, Bend, OR (US); Daniel Anthony De Grossa, Bend, OR (US)

(21) Appl. No.: 12/932,030

(22) Filed: Feb. 15, 2011

Related U.S. Application Data
(60) Provisional application No. 61/339,162, filed on Feb. 24, 2010.

(51) Int. Cl. A01G 13/02; B23P 17/04

(52) U.S. Cl. 47/22.1; 47/20.1; 29/428

(57) ABSTRACT

A garden enclosure apparatus and means for assembling the same is set forth, including a circular base frame, a dome topped superstructure having a removable hatch, the superstructure resting upon the circular base frame, and in the preferred embodiment, the removable hatch is hinged to the base frame, and benefits from a spring lift assist means to open and close the removable hatch providing access to the protected area within.

### CROSS REFERENCE TO RELATED APPLICATION

The present application claims the benefit of U.S. provisional Application No. 61-339,162 filed on Feb. 24, 2010 which is incorporated herein by reference.

### TECHNICAL FIELD OF THE INVENTION

The present invention relates to plant enclosures, and more particularly pertains to a new and improved plant enclosure apparatus that provides protection from undesired elements and animals while allowing easy human access.

### DESCRIPTION OF THE RELATED ART

Prior art devices have attempted to set forth plant cages, nets and the like to protect and/or support a plant or plants, but have heretofore, to the inventor's best knowledge, failed to provide the advantages of the instant invention. For example, U.S. Pat. No. 4,005,548 to Nahon sets forth a plant support cage wherein a plurality of upright support rods includes crossed-wire holders but the cage does not provide protection from the elements or animals. Further, access to the plants within the Nahon structure is inhibited, as there are no doors or hatches.

U.S. Pat. No. 4,026,068 to Tepper sets forth a tomato plant cage organization wherein pluralities of aligned stakes are provided with a series of lateral members extending from the stakes to support vines of an associated plant. The lateral supports are positioned to accommodate plant growth, but do not provide any substantive protection for undesired weather elements nor protection from damaging animals.

U.S. Pat. No. 5,544,446 to Benson sets forth a plant protector provided with a plurality of rectangular sections connected by hinge mechanisms but does not provide easy access to the enclosed space or protection from the elements. Further, #446 fails to provide protection from above, allowing jumping deer or birds to enter the desired protected area.

It is appreciated that there continues to be an unsolved problem of protecting plants grown outdoors from undesirable weather elements and damaging animals, while allowing for easy human access to tend to the plants within.

### SUMMARY OF THE INVENTION

The present invention provides a new and improved hinged garden enclosure apparatus that solves the shortcomings in the prior art.

To invention comprises a base frame with a hinged bracket, a dome frame, optional dome frame covers, which may be meshed, or heat trapping, and a lift spring assembly that enables human gardeners to open and close a portion of the dome frame easily. The dome frame is comprised of a superstructure which provides structural integrity both in the open and closed positions. To increase rigidity in the closed position, the dome frame fittingly contacts a base frame that remains on the ground.

The invention may not reside in any one of these features per se, but rather in the particular combination of key components disclosed and claimed and it is distinguished from the prior art in this particular combination of parts and their specified functions.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims included herein. Those skilled in the art will appreciate that the concepts, upon which this disclosure is based, may readily be utilized as a basis for the designing of other structures, methods and systems for carrying out the several purposes of the present invention. It is important, therefore, that the disclosure and claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings, claims and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective illustration of an embodiment of the instant invention.

FIG. 2 is an isometric top-view illustration of an embodiment of the instant invention.

FIG. 3 is an isometric side-view illustration of an embodiment of the instant invention.

### DETAILED DESRIPTION OF THE DRAWINGS

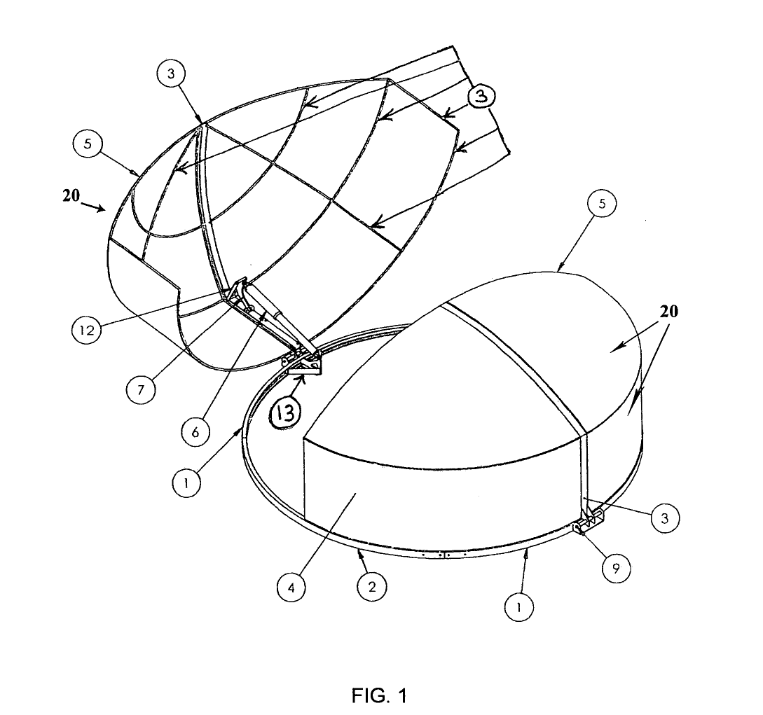

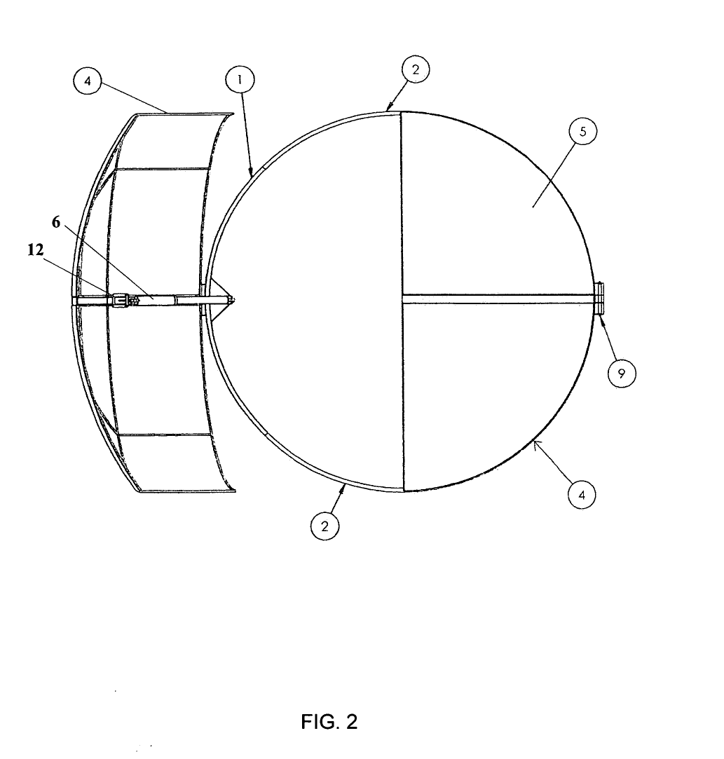

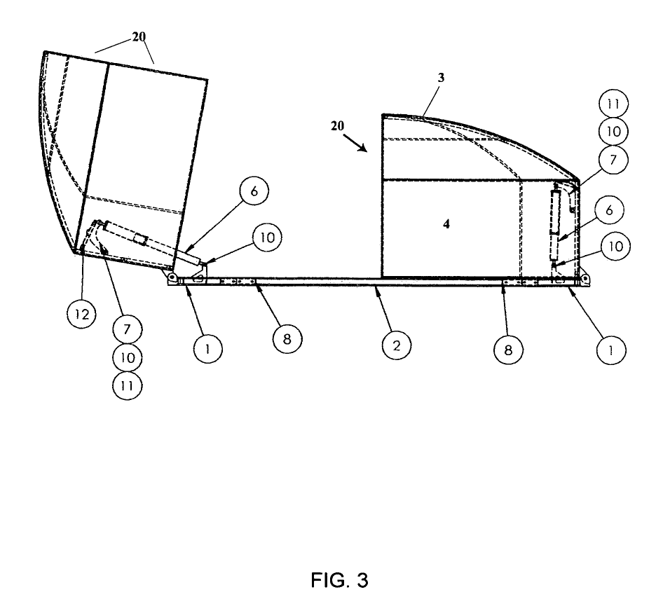

With reference now to the drawings, and in particular to FIGS. 1 to 3 thereof, a new and improved protective garden enclosure apparatus embodying the principles and concepts of the present invention and generally designated by the reference numerals 1 through 12 will be described.

More specifically, it will be noted that the protective garden enclosure preferred embodiment essentially comprises a base frame, a dome, a dome hatch and a spring assembly. The embodiment of the instant invention illustrated in FIGS. 1, 2 and 3 includes a base frame 2 with hinge bracket 1, a dome frame 3, a cylindrical wall 4, a mesh cover 5, a lift assembly 6, a bracket 7, a splice plate 8 (for the embodiment where in the base frame consists of more than one part), a hinge pin assembly 9, bushing 10, flange 11 and extension spring 12.

Base frame 1 is attachable to base frame 2 at splice plate 8 for the preferred embodiment, the entire base frame may be constructed of a single piece in other embodiments. Together they form a circular base.

Hinge pin assembly 9 allows dome frame 3 to articulate in relationship to the entire base frame, which may be secured to the earth with stakes or other means known in the art.

An alternative embodiment of the instant invention includes a mesh cover 5 that further adds protection for the plants within the growing area, or may provide beneficial shade for chickens or other animals kept within. Covers, which may be affixed to the dome superstructure 3 may retain heat or alternatively block solar gain for plants in the enclosure.

As shown, the cylindrical wall 4 is of the same diameter as the base frame 1-2 and is constructed and arranged to rest upon the base frame 1-2. The dome frame 3 is of the same corresponding diameter as the cylindrical wall 4, and may be fabricated all together or as two pieces and then assembled together to form the superstructure in combination. The space within the frames or wires of the superstructure 20 (dome frame 3 or cylindrical wall 4) may be of sufficient spacing to block most animals from accessing plants in the defined enclosure. Alternatively a non-structural screen may be added to superstructure 20 to prevent smaller animals and birds from accessing such plants. Any cover may serve such a function as well.

Bracket 7, which is hingedly mounted at both ends, provides means for hingedly attaching one end of lift assembly 6 to superstructure 20 and extension spring 12 wherein spring 12 is compressed, and therefore stores energy, when closed. Preferably, given the potential weight of the dome hatch, if it is built of steel or materials of similar density and is large, perhaps a four foot radius and 180 degrees of a circular base requires a relatively high energy spring. To dampen the force of a high energy spring a second spring, extension spring 12, may be added to dampen the force of a simple coil spring used in lift assembly 6. Alternatively lift assembly 6 may include dampening mechanisms which are well known in the art.

Spring calibration is critical to the proper functioning of the instant invention. A range of useful spring mechanisms, or functional equivalents thereof such as hydraulics, could be used in the instant invention including simple coil spring devices. The rate of each spring again is critical to allow for ergonomic and easy use of the instant invention.

FIG. 1 illustrates an embodiment of the instant invention wherein dome superstructure 20 is comprised of two identical semicircular sections. Alternatively, only a portion of the superstructure 3 may open, or functions as a door or removable hatch which may be opened and closed in accordance with a users desire to access the inside of the enclosure or leave the enclosure closed for protection, viewing and other uses. It should be appreciated the shape of the dome frame, dome hatch and base frame may vary.

In embodiments of the instant invention wherein covers are employed risks of inadvertent opening or closing of the hatch are possible. Therefore, embodiments of the instant invention include releasable safety latches which maintain the dome hatch in either an open or closed position. A user would have to release the latch if she desired to open or close the hatch. The latch or latches may be any of a range of locking mechanisms known in the art. Such locking mechanisms could be conveniently located at hinge pin 9 on base frame 2 and/or located on superstructure 20. It is preferred the dome hatch, or other shaped hatch, is opened and closed by the user by the user grabbing with their hand a handle, which may include a locking mechanism, and pulling the hatch open by pulling it directly toward the use's chest, in the same vertical plane as lift assembly 6 and extension spring 12 and hinge mechanism 9. Such forces, when opening and closing the hatch, will help maintain the shape of the hatch insuring that it will properly marry with the entire base frame after numerous opening/closing cycles.

Though not illustrated in the figures, the instant invention anticipates means for marrying an irrigation system to a portion of the base frame 1-2 and/or superstructure 20 wherein irrigation hosing or lines may be aesthetically and ergonomically attached to those structural elements to deliver need hydration to plants in the enclosure or provide cooling, with misting irrigation heads as opposed to sprinklers or drip irrigation, during hot weather.

Though not illustrated in the figures, the instant invention anticipates means for marrying a heat source, such as a light bulb and battery and/or solar array, to a portion of the entire base frame 1-2 and/or superstructure 20 wherein necessary radiation may be aesthetically and ergonomically provided and attached to those structural elements or members. If the radiation source requires an interface with a different energy source wiring may be attached to, and/or integrated with the necessary super structure 3 and/or entire base frame elements.

Dome frame 3 may be of any of a number of configurations, however, orthogonally oriented members, whether the instant invention is of a circular, square or rectangular shape will likely provide the necessary structural integrity with a minimum of materials and weight.

Channels in the structural elements or members of the instant invention may provide routing for water or electrical systems wherein the mechanics of snap-fit may be utilized to integrate alternative systems, whether water, electrical or other, with the instant enclosure.

A horizontal plastic strip may be abutted to the inside wall of the entire base frame such that fertile soil may be added into the enclosure if existing soil is inadequate wherein in the outward static force. The plastic strip may be similar to lawn edging strips known in the art with sufficient pliability to be substantially wrapped along the inside wall of the entire base frame, regardless of the shape of the entire base frame, yet the rigidity to hold the fertile soil in place within the enclosure.

The present preferred embodiment of the instant invention includes a base frame 1-2 of an approximate diameter of 8 feet and a superstructure 20 height of 4 feet.

It should be underscored the desirability to easily access the interior of the enclosure for planting, weeding, picking or any other actions within the enclosure desired by its user. Moreover, it should be underscored the desirability to see the interior of the enclosure; whether there are flowers or animals in the enclosure.

It should be underscored that the protective enclosure may not be merely for plants. Chicken coops, for example, need a minimal space.

The manner of usage and operation therefore of the instant invention should be apparent from the above description, and accordingly no further discussion relative to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of one preferred embodiment. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The invention claimed is:

1. A protective garden enclosure comprising:
a dome topped superstructure having at least one removable hatch; and
a circular base in diameter circumscribing a protected area;
the superstructure being constructed and arranged to fittingly rest on the circular base.

2. A protective garden enclosure according to claim 1, wherein an open-assist means having a first end attaching to the circular base and a second end attaching to the super structure.

3. A protective garden enclosure according to claim 2, wherein the open-assist means includes a spring.

4. A protective garden enclosure according to claim 2, wherein the open-assist means is a gas strut.

5. A protective garden enclosure according to claim 2, wherein the open-assist means is a compression spring formed on a resilient elastic body.

6. A protective garden enclosure according to claim 1, wherein a latching mechanism engages the removable hatch to the superstructure.

7. A protective garden enclosure according to claim 1, wherein a cover fixates to the superstructure.

8. A protective garden enclosure according to claim 1, wherein the removable hatch is hinged to the base frame.

9. A protective garden enclosure according to claim 7, wherein the cover is an impervious material.

10. A protective garden enclosure according to claim 7, wherein the cover is a wire cage.

11. A protective garden enclosure according to claim 1, wherein the superstructure consists of a cylindrical wall having a dome shaped top, open at the bottom.

12. A protective garden enclosure according to claim 1, wherein a water deliver means is integrated with the superstructure or the circular base.

13. A protective garden enclosure according to claim 1, wherein a heat source is fixated to the superstructure or circular base.

14. A protective garden enclosure according to claim 1, wherein a heat source is integral to the superstructure or circular base.

15. A protective garden enclosure according to claim 1, wherein a wheel set is fixated to the circular base.

16. A protective garden enclosure according to claim 1, wherein the base frame is constructed of more than one part.

17. A method of making a protective garden enclosure, which comprises:
assembling a base frame in the shape of a circle;
fabricating a super structure having a cylinder wall in matching diameter as the base frame, having a dome fabricated on one end of the cylindrical wall, open on the other end, having at least one removable hatch;
resting the open end of the super structure onto the base frame.

18. A method of making a protective garden enclosure according to claim 17, including the additional step of:
hinging the removable hatch to the base frame.

19. A method of making a protective garden enclosure according to claim 17, including the additional step of:
hinging the super structure to the base frame.

20. A method of making a protective garden enclosure according to claim 17, including the additional step of:
attaching a lift assist means between the superstructure and the base frame.
